(19) United States
(12) Patent Application Publication
(10) Pub. No.: US 2026/0203305 A1
(43) Pub. Date: Jul. 16, 2026

(54) METHOD AND SYSTEM FOR PROVIDING TAXONOMY-BASED FRAMEWORK FOR POLICY AND RULE MANAGEMENT

(71) Applicant: JPMorgan Chase Bank, N.A., New York, NY (US)

(72) Inventors: Aditi JUBAL, Bengaluru (IN); Debadatta PANDA, Bengaluru (IN); Sushil KUMAR, Bengaluru (IN); Amith PRAMOD, Bengaluru (IN)

(73) Assignee: JPMorgan Chase Bank, N.A., New York, NY (US)

(21) Appl. No.: 19/064,192

(22) Filed: Feb. 26, 2025

(30) Foreign Application Priority Data
Jan. 13, 2025 (IN) 202511002896

(51) Int. Cl. G06F 16/28

(52) U.S. Cl. CPC G06F 16/282

(57) ABSTRACT

A method and system for providing taxonomy-based framework for policy and rule management is disclosed. The method is implemented by at least one processor. The method includes receiving using a policy and rule manager, a trigger event from a service for execution of a plurality of rules associated with a plurality of policies. Next, the method includes retrieving a set of rule details for the plurality of rules from a taxonomy-based datastore. Next, the method includes retrieving a dataset for applying the plurality of rules, from the taxonomy-based datastore. Next, the method includes applying the plurality of rules to the dataset. Thereafter, the method includes executing the plurality of rules for performing an action and storing a result of the action in the taxonomy-based datastore.

### CROSS-REFERENCE TO RELATED APPLICATIONS

This application claims priority benefit from Indian Application No. 202511002896, filed on Jan. 13, 2025, in the India Patent Office, which is hereby incorporated by reference in its entirety.

### FIELD OF THE DISCLOSURE

This technology generally relates to management of policies, rules, and their implementation in complex and data-driven environments, and more particularly relates to method and system for providing taxonomy-based framework for policy and rule management.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In recent years, the demand for computational power to solve complex problems and process large-scale data sets has increased exponentially across various fields. Traditional computing architectures often struggle to meet the requirements of these demanding tasks due to limitations in processing power, memory, and scalability. As a result, there has been growing interest in developing applications capable of using parallel data processing (such as high-performance distributed applications or high computing applications) to improve computing performance and perform complex calculations.

Managing policies, rules, and their implementation in complex and data-driven environments present several challenges. One of the primary difficulties is the complexity of defining and maintaining a large set of interdependent policies and rules, particularly when these need frequent updates or modifications.

Traditional systems for rule management present technical problems. They often lack structure, leading to errors and inefficiencies. Additionally, testing and validating these policies to ensure correct functionality before deployment is a significant issue, as existing methods can be time-consuming, error-prone, and ineffective, especially when dealing with large volumes of data and complex interdependencies. Executing rules efficiently, particularly in real-time or near-real-time scenarios, is another issue, as many systems are not optimized to handle vast amounts of data quickly and without impacting performance.

During testing, it is not always clear what the source of detected errors are, such that traditional methods must continuously change and retest the rules. A technical problem with this methodology is that each test consumes a great deal of computer resources and electrical power, such that continual resubmission of rules for tests in search of a satisfactory rule development and execution consumers that much more power and computer resources. Simply stated, receiving a satisfactory outcome after ten tests consumes far more power than receiving a satisfactory response after one test.

As business requirements evolve, rule management systems must be able to integrate new data sources, handle diverse inputs and outputs, and scale effectively without compromising performance or resilience. Many existing systems struggle with scalability, often requiring costly and rigid infrastructure. Furthermore, a lack of transparency in decision-making and limited historical analysis can hinder accountability and optimization. Without the ability to trace policy execution or review past performance, organizations face difficulties in refining their rules or ensuring compliance. These issues underscore the need for a more structured, efficient, and flexible framework that can address the complexities of policy and rule management in dynamic, data-intensive environments.

Hence, in view of these and other existing limitations, there arises an imperative need to provide an efficient solution to overcome the above-mentioned limitations and to provide a method and system that provides taxonomy-based framework for policy and rule management for a plurality of policies, which relies on a reduced need for testing and corresponding reduction in power consumption.

### SUMMARY

The present disclosure, through one or more of its various aspects, embodiments, and/or specific features or sub-components, provides, inter alia, various systems, servers, devices, methods, media, programs, and platforms to provide taxonomy-based framework for policy and rule management.

According to an aspect of the present disclosure, a method for providing taxonomy-based framework for policy and rule management is disclosed. The method is implemented by at least one processor. The method includes receiving, by the at least one processor, via a policy and rule manager, a trigger event from a service for execution of a plurality of rules associated with a plurality of policies. Next, the method includes retrieving, by the at least one processor, a set of rule details for the plurality of rules from a taxonomy-based datastore. Next, the method includes retrieving, by the at least one processor, a dataset for applying the plurality of rules, from the taxonomy-based datastore. Next, the method includes applying, by the at least one processor, the plurality of rules to the dataset to trigger execution of the plurality of rules. Next, the method includes executing, by the at least one processor, the plurality of rules for performing an action. Next, the method includes storing, by the at least one processor, a result of the action in the taxonomy-based datastore.

In accordance with an exemplary embodiment, the plurality of rules associated with the plurality of policies are categorized in a hierarchical classification and stored in the taxonomy-based datastore. In addition, the plurality of rules are defined to be executed in a sequence.

In accordance with an exemplary embodiment, the hierarchical classification includes classifying, by the at least one processor, the plurality of policies and the associated plurality of rules based on a plurality of pre-defined rule-taxonomy categories. Next, the hierarchical classification includes organizing, by the at least one processor, the classified plurality of policies and the associated plurality of rules in a hierarchical taxonomy structure within the taxonomy-based datastore.

In accordance with an exemplary embodiment, the method includes recording, by the at least one processor, an audit trail of the action. Next, the method includes saving, by the at least one processor, the audit trail in the taxonomy-based datastore.

In accordance with an exemplary embodiment, for recording the audit trail of the action, the method includes logging a set of entries, by the at least one processor, for execution of each rule of the plurality of rules. Each entry from the set of entries includes metadata associated with the trigger event. The metadata includes at least a timestamp, a user identifier, and a rule version.

In accordance with an exemplary embodiment, prior to receiving the trigger event, the method includes defining a plurality of rule attributes for the plurality of rules. The plurality of rule attributes includes at least one from among rule definition, rule unique identity, rule type, and rule status.

In accordance with an exemplary embodiment, the method further includes testing the plurality of rules from the taxonomy-based datastore.

In accordance with an exemplary embodiment, for testing the plurality of rules, the method includes retrieving, by the at least one processor, a rule test data associated with the plurality of rules for the plurality of policies from a plurality of sources. Next, the method includes evaluating, by the at least one processor, the rule test data to generate rule testing result. The rule testing result is generated by comparing the rule test data with a plurality of predefined conditions associated with the plurality of policies. Next, the method includes verifying, by the at least one processor, whether the rule testing result meets the plurality of predefined conditions. Next, the method includes adjusting, by the at least one processor, the plurality of rules based on the rule testing result if the rule testing result fails to meet the plurality of predefined conditions.

In accordance with an exemplary embodiment, the method includes validating, by the at least one processor, the plurality of rules based on the rule testing result. Next, the method includes updating, by the at least one processor, the rule status of each of the plurality of rules to one of active status and an inactive status. The active status indicates successful validation and the inactive status indicates unsuccessful validation.

According to another aspect of the present disclosure, a computing device configured to implement an execution of a method for providing taxonomy-based framework for policy and rule management is disclosed. The computing device includes a processor; a memory storing instructions; and a communication interface coupled to each of the processor and the memory. The processor may be programmed to cooperate with the instructions to perform operations including: receive, via a policy and rule manager, a trigger event from a service for execution of a plurality of rules associated with a plurality of policies; retrieve a set of rule details for the plurality of rules from a taxonomy-based datastore; retrieve a dataset for applying the plurality of rules, from the taxonomy-based datastore; apply the plurality of rules to the dataset to trigger execution of the plurality of rules; execute the plurality of rules for performing an action; and store a result of the action in the taxonomy-based datastore.

In accordance with an exemplary embodiment, the plurality of rules associated with the plurality of policies are categorized in a hierarchical classification and stored in the taxonomy-based datastore. In addition, the plurality of rules are defined to be executed in a sequence.

In accordance with an exemplary embodiment, the hierarchical classification includes classifying, by the at least one processor, the plurality of policies and the associated plurality of rules based on a plurality of pre-defined rule-taxonomy categories. Next, the hierarchical classification includes organizing, by the at least one processor, the classified plurality of policies and the associated plurality of rules in a hierarchical taxonomy structure within the taxonomy-based datastore.

In accordance with an exemplary embodiment, the operations further include record an audit trail of the action. Next, the processor is configured to save the audit trail in the taxonomy-based datastore.

In accordance with an exemplary embodiment, to record the audit trail of the action, the operations further include log a set of entries for execution of each rule of the plurality of rules. Each entry from the set of entries includes metadata associated with the trigger event. The metadata includes at least a timestamp, a user identifier, and a rule version.

In accordance with an exemplary embodiment, prior to receiving the trigger event, the operations further include define a plurality of rule attributes for the plurality of rules. The plurality of rule attributes includes at least one from among rule definition, rule unique identity, rule type, and rule status.

In accordance with an exemplary embodiment, the operations further include test the plurality of rules from the taxonomy-based datastore.

In accordance with an exemplary embodiment, to test the plurality of rules, the operations further include retrieve a rule test data associated with the plurality of rules for the plurality of policies from a plurality of sources. Next, the operations further include evaluate the rule test data to generate rule testing result. The rule testing result is generated by comparing the rule test data with a plurality of predefined conditions associated with the plurality of policies. Next, the operations further include verify whether the rule testing result meets the plurality of predefined conditions. Next, the operations further include adjust the plurality of rules based on the rule testing result if the rule testing result fails to meet the plurality of predefined conditions.

In accordance with an exemplary embodiment, the operations further include validate the plurality of rules based on the rule testing result. Next, the operations further include update the rule status of each of the plurality of rules to one of active status and an inactive status. The active status indicates successful validation and the inactive status indicates unsuccessful validation.

According to yet another aspect of the present disclosure, a non-transitory computer-readable storage medium storing instructions for providing taxonomy-based framework for policy and rule management is disclosed. The instructions include executable code which, when executed by a processor, may cause the processor to perform operations including receive, via a policy and rule manager, a trigger event from a service for execution of a plurality of rules associated with a plurality of policies; retrieve a set of rule details for the plurality of rules from a taxonomy-based datastore; retrieve a dataset for applying the plurality of rules, from the taxonomy-based datastore; apply the plurality of rules to the dataset to trigger execution of the plurality of rules; execute the plurality of rules for performing an action; and store a result of the action in the taxonomy-based datastore.

In accordance with an exemplary embodiment, the plurality of rules associated with the plurality of policies are categorized in a hierarchical classification and stored in the taxonomy-based datastore. In addition, the plurality of rules are defined to be executed in a sequence.

In accordance with an exemplary embodiment, the hierarchical classification includes classifying, by the at least one processor, the plurality of policies and the associated plurality of rules based on a plurality of pre-defined rule-taxonomy categories. Next, the hierarchical classification includes organizing, by the at least one processor, the classified plurality of policies and the associated plurality of rules in a hierarchical taxonomy structure within the taxonomy-based datastore.

In accordance with an exemplary embodiment, the executable code, which when executed causes the processor to record an audit trail of the action. Next, the operations further include save the audit trail in the taxonomy-based datastore.

In accordance with an exemplary embodiment, to record the audit trail of the action, the executable code, which when executed causes the processor to log a set of entries for execution of each rule of the plurality of rules. Each entry from the set of entries includes metadata associated with the trigger event. The metadata includes at least a timestamp, a user identifier, and a rule version.

In accordance with an exemplary embodiment, prior to receiving the trigger event, the executable code when executed causes the processor to define a plurality of rule attributes for the plurality of rules. The plurality of rule attributes includes at least one from among rule definition, rule unique identity, rule type, and rule status.

In accordance with an exemplary embodiment, the executable code, which when executed causes the processor to test the plurality of rules from the taxonomy-based datastore.

In accordance with an exemplary embodiment, to test the plurality of rules, the executable code, which when executed causes the processor to retrieve a rule test data associated with the plurality of rules for the plurality of policies from a plurality of sources. Next, the operations further include evaluate the rule test data to generate rule testing result. The rule testing result is generated by comparing the rule test data with a plurality of predefined conditions associated with the plurality of policies. Next, the operations further include verify whether the rule testing result meets the plurality of predefined conditions. Next, the operations further include adjust the plurality of rules based on the rule testing result if the rule testing result fails to meet the plurality of predefined conditions.

In accordance with an exemplary embodiment, the executable code, which when executed causes the processor to validate the plurality of rules based on the rule testing result. Next, the operations further include update the rule status of each of the plurality of rules to one of an active status and an inactive status. The active status indicates successful validation and the inactive status indicates unsuccessful validation.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system to provide taxonomy-based framework for policy and rule management, in accordance with an exemplary embodiment of the present disclosure.

FIG. 2 illustrates an exemplary diagram of a network environment to provide taxonomy-based framework for policy and rule management, in accordance with an exemplary embodiment of the present disclosure.

FIG. 3 illustrates an exemplary system to provide taxonomy-based framework for policy and rule management, in accordance with an exemplary embodiment of the present disclosure.

FIG. 4 illustrates an exemplary method flow diagram to provide taxonomy-based framework for policy and rule management, in accordance with an exemplary embodiment of the present disclosure.

FIG. 5A illustrates an architecture of the exemplary system in view of a rule setup flow, in accordance with an exemplary embodiment of the present disclosure.

FIG. 5B illustrates an architecture of an exemplary system in view of a rule decision and execution flow, in accordance with an exemplary embodiment of the present disclosure.

FIG. 6 illustrates another architecture of the exemplary system to provide taxonomy-based framework for policy and rule management, in accordance with an exemplary embodiment of the present disclosure.

FIG. 7 illustrates a first sequence diagram of the exemplary system to provide taxonomy-based framework for policy and rule management, in accordance with an exemplary embodiment of the present disclosure.

FIG. 8 illustrates a second sequence diagram of an exemplary system to trigger execution of rules for a taxonomy-based framework for policy and rule management and execution, in accordance with an exemplary embodiment of the present disclosure.

### DETAILED DESCRIPTION

Exemplary embodiments will now be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

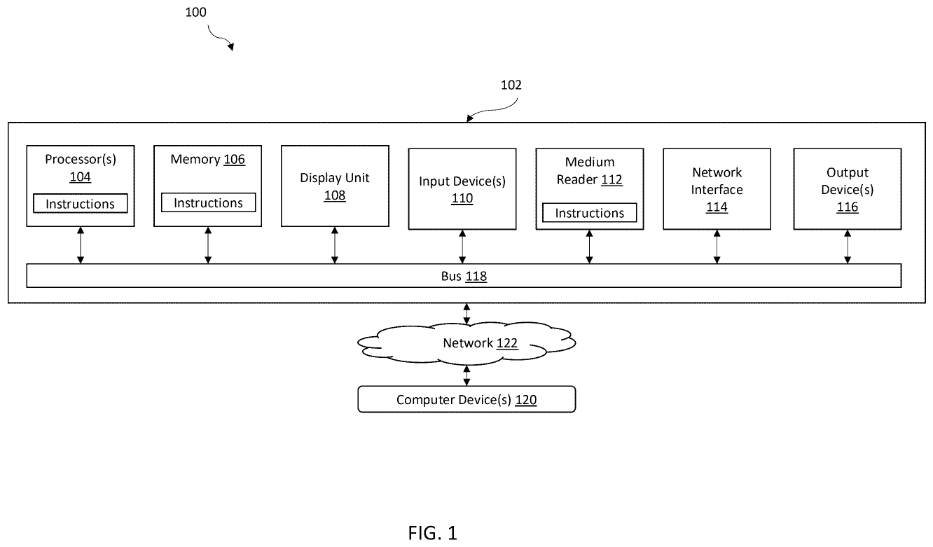

FIG. 1 is an exemplary system 100 for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to provide taxonomy-based framework for policy and rule management for a plurality of policies.

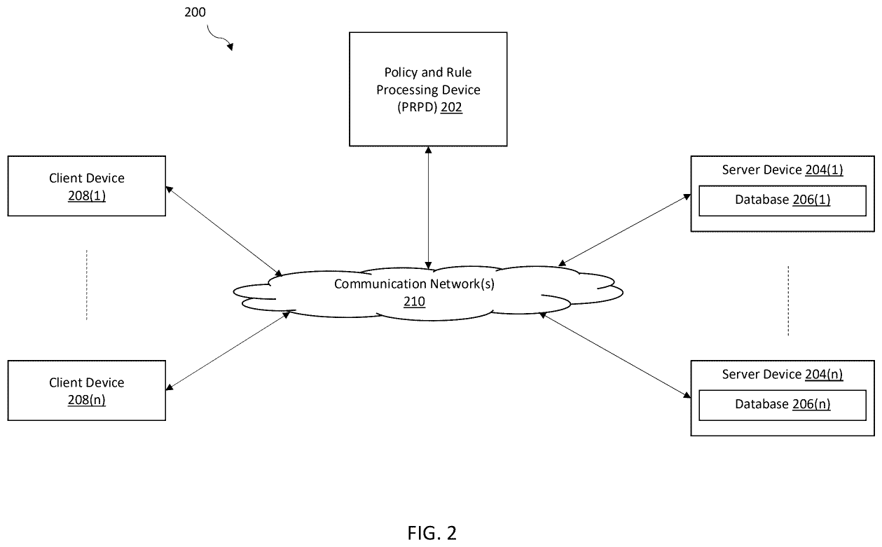

Referring to FIG. 2, a schematic diagram of an exemplary network environment 200 to provide taxonomy-based framework for policy and rule management for a plurality of policies is illustrated. In an exemplary embodiment, the method is executable on any networked computer platform, such as, for example, a personal computer (PC).

The method to provide taxonomy-based framework for policy and rule management may be executed by a policy and rule processing device (PRPD) 202. The PRPD 202 may be the same or similar to the computer system 102 as described with respect to FIG. 1. The PRPD 202 may store one or more applications that may include executable instructions that, when executed by the PRPD 202, cause the PRPD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the PRPD 202 itself, may be located in the virtual server(s) running in a cloud-based computing environment rather than being tied to one or more specific physical network computing devices. Also, the application(s) may be running in one or more virtual machines (VMs) executing on the PRPD 202. Additionally, in one or more embodiments of this technology, virtual machine(s) running on the PRPD 202 may be managed or supervised by a hypervisor.

In the network environment 200 of FIG. 2, the PRPD 202 is coupled to a plurality of server devices 204(1)-204(n) that hosts a plurality of databases 206(1)-206(n), and also to a plurality of client devices 208(1)-208(n) via communication network(s) 210. A communication interface of the PRPD 202, such as the network interface 114 of the computer system 102 of FIG. 1, operatively couples and communicates between the PRPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PRPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and PRPDs that efficiently implement the method to provide taxonomy-based framework for policy and rule management.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The PRPD 202 may be a standalone device or integrated with one or more other devices or apparatuses, such as one or more of the server devices 204(1)-204(n), for example. In one particular example, the PRPD 202 may include or be hosted by one of the server devices 204(1)-204(n), and other arrangements are also possible. Moreover, one or more of the devices of the PRPD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the PRPD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data related to a plurality of policies and a plurality of rules.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the PRPD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the PRPD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the PRPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PRPD 202, the server devices 204(1)-204(n), or the client devices 208(1)-208(n), for example, may be configured to operate as virtual instances on the same physical machine. In other words, one or more of the PRPD 202, the server devices 204(1)-204(n), or the client devices 208(1)-208(n) may operate on the same physical device rather than as separate devices communicating through communication network(s) 210. Additionally, there may be more or fewer PRPDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

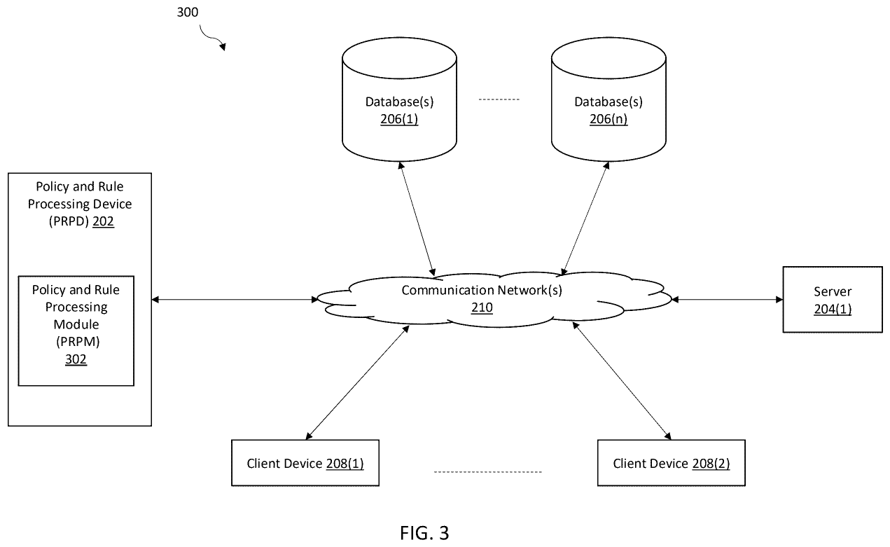

FIG. 3 illustrates an exemplary system to provide taxonomy-based framework for policy and rule management for a plurality of policies, in accordance with an exemplary embodiment. As illustrated in FIG. 3, according to exemplary embodiments, the system 300 may comprise a policy and rule processing device (PRPD) 202 including a policy and rule processing module (PRPM) 302 that may be connected to a server device 204(1) and one or more repository from the repositories 206(1) . . . 206(n) via a communication network 210, but the disclosure is not limited thereto.

The PRPD 202 described and shown in FIG. 3 includes the PRPM 302, although it may include other rules, policies, modules, databases, or applications, for example. As will be described below, the PRPM 302 is configured to carry out a method to provide taxonomy-based framework for policy and rule management.

An exemplary system 300 for enabling a mechanism to provide taxonomy-based framework for policy and rule management of FIG. 2 is shown as being executed in FIG. 3. Specifically, a first client device 208(1) and a second client device 208(2) are illustrated as being in communication with the PRPD 202. In this regard, the first client device 208(1) and the second client device 208(2) may be “clients” of the PRPD 202 and are described herein as such. Nevertheless, it is to be known and understood that the first client device 208(1) and/or the second client device 208(2) need not necessarily be “clients” of the PRPD 202, or any entity described in association therewith herein. Any additional or alternative relationship may exist between either or both of the first client device 208(1) and the second client device 208(2) and the PRPD 202, or no relationship may exist.

Further, the PRPD 202 is illustrated as being able to access one or more repositories 206(1) . . . 206(n). The PRPM 302 may be configured to access these repositories/databases to provide a method for providing taxonomy-based framework for policy and rule management.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the PRPD 202 via broadband or cellular communication. These embodiments are merely exemplary and are not limiting or exhaustive.

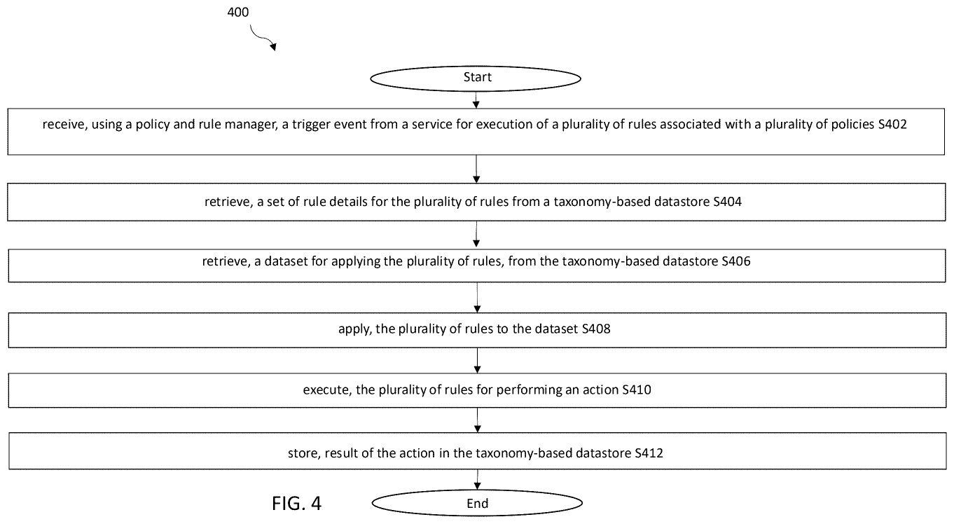

Referring to FIG. 4, an exemplary method 400 is shown for providing taxonomy-based framework for policy and rule management, in accordance with an exemplary embodiment. In particular, the exemplary method 400 is shown for providing taxonomy-based framework for policy and rule management for a plurality of policies.

As shown in FIG. 4, the method 400 begins following a need to provide taxonomy-based framework for policy and rule management. The method 400 is implemented by at least one processor 104. In an implementation, the method 400 may be performed by an exemplary system (herein after system) that may be a computing device 100 of FIG. 1.

At step S402, the method 400 includes receiving, by the at least one processor 104, using a policy and rule manager, a trigger event from a service for execution of a plurality of rules associated with the plurality of policies. The term “plurality of policies” refers to a collection of guidelines or strategies that directs how the plurality of rules may be applied to any dataset. For example, in a banking system, anti-money laundering policy may encompass various rules designed to detect and prevent money laundering activities such as flagging large transactions, monitoring unusual behavior, and tracking high-risk users or customers. In an implementation, prior to receiving the trigger event, the method 400 includes defining a plurality of rule attributes for the plurality of rules. The plurality of rule attributes includes at least one from among rule definition, rule unique identity, rule type and rule status. In an example, a rule in a fraud detection system may be defined with the plurality of rule attributes such as “rule ID: R12345,” “rule type: transaction monitoring,” and “status: active.” The plurality of attributes are useful for distinguishing and managing the plurality of rules within the system or the at least one processor 104.

Generally, the trigger event refers to a specific occurrence or condition that initiates or activates a particular action, process, or set of rules in a system or the at least one processor 104. In addition, the trigger event is an event that prompts the system or the at least one processor 104 to begin executing a defined set of tasks, such as processing data, applying rules, or performing an action. The term “trigger event” herein may correspond to an action, system state change, or a user interaction that initiates a set of actions according to predefined rules.

The term “service” herein may correspond to an application, system or component that triggers actions or processes based on events or conditions. In an example, in a banking system, a service may be a transaction processing system that initiates actions such as transferring funds, applying fraud detection, verifying customer information and the like.

At step S404, the method 400 includes retrieving, by the at least one processor 104, a set of rule details for the plurality of rules from a taxonomy-based datastore. The plurality of rules may be predefined rules that direct the system or the at least one processor 104 to perform certain actions based on specific conditions and where the set of rule details are associated with detailed information for each of the plurality of rules. In an implementation, a rule of the plurality of rules may be “if a customer's credit score is below 600, reject loan application for a certain amount of loan for that customer”. In this scenario, the set of rule details may be data such as a threshold loan amount for which the loan application needs to be rejected.

In an implementation, the method 400 includes testing the plurality of rules from the taxonomy-based datastore. The testing of the plurality of rules is done before executing the plurality of rules. For testing the plurality of rules, the method 400 includes retrieving, by the at least one processor, a rule test data associated with the plurality of rules for the plurality of policies from a plurality of sources. In an implementation, the plurality of sources includes but is not be limited to data repositories, and third-party databases. The method 400 further includes evaluating, by the at least one processor, the rule test data to generate rule testing result. The rule testing result is generated by comparing the rule test data with a plurality of predefined conditions associated with the plurality of policies. The method 400 includes verifying, by the at least one processor 104, whether the rule testing result meets the plurality of predefined conditions. Also, the method 400 includes adjusting, by the at least one processor 104, the plurality of rules based on the rule testing result if the rule testing result fails to meet the plurality of predefined conditions. Generally, the plurality of predefined conditions refer to a set of criteria or rules against which behavior, functionality, and correctness of the plurality of rules and the plurality of policies are validated. The plurality of predefined conditions may be set by a user, an administrator or the system itself.

The method 400 includes validating, by the at least one processor 104, the plurality of rules based on the rule testing result. Further, the method 400 includes updating, by the at least one processor 104, the rule status of each of the plurality of rules to one of an active status and an inactive status. For example, in a financial risk assessment system, a rule that ensures compliance with new regulations may be validated by testing against recent transaction data. If the rule passes, it remains “active”; if it fails, it is updated to “inactive” until adjustments are made.

In an example, the trigger event may be associated with banking or finance. Let us assume that a customer initiates a wire transfer that exceeds a certain threshold (e.g., $15000). The system may retrieve the set of rule details such as anti-money laundering (AML) checks (e.g., flagging large transactions for review). This trigger event ensures compliance with financial regulations that require certain actions to be taken when a large transaction occurs.

In another example, the trigger event may be associated with e-commerce. Let us assume that a customer adds items to their shopping cart and proceeds to checkout. The event of adding items to their shopping cart is the trigger event in this case. The system may retrieve the set of rule details such as discount eligibility, payment processing and inventory checks as the trigger event is received.

The plurality of rules associated with the plurality of policies are stored in the taxonomy-based datastore. In an implementation, the plurality of rules associated with the plurality of policies are categorized in a hierarchical classification. The hierarchical classification includes classifying, by the at least one processor 104, the plurality of policies and the associated plurality of rules based on a plurality of pre-defined rule-taxonomy categories. For example, let us assume, in a regulatory compliance system, policies such as “anti-money laundering” may be classified into subcategories like “transaction monitoring, “customer due diligence”, and the like.

Also, the hierarchical classification includes organizing, by the at least one processor 104, the classified plurality of policies and the associated plurality of rules in a hierarchical taxonomy structure within the taxonomy-based datastore.

The plurality of rules may be defined to be executed in a sequence. The sequence herein refers to a specific order. In an implementation, the plurality of rules are defined to be executed in a specific order, such that the result of one rule might affect the execution of subsequent rules. The execution of the plurality of rules in the specific order ensures the correct application of the plurality of policies and the plurality of rules in a logical sequence. For example, in a loan approval system, a first rule may be to check if the applicant's credit score meets a minimum threshold. If the first rule passes, a second rule may be checked. The second rule may be for checking whether the applicant's income is sufficient to meet loan requirements. If the first rule fails, subsequent rules (the second rule in this example) are not executed.

At step S406, the method 400 includes retrieving, by the at least one processor, a dataset for applying the plurality of rules, from the taxonomy-based datastore. The taxonomy-based datastore is a datastore that organizes the plurality of rules and the plurality of policies according to a predefined taxonomy.

In an implementation, the dataset may be user data, customer data, transaction data and the like. The dataset is retrieved based on the received trigger event. For example, if the trigger event is an event when a customer initiates a high-value financial transaction, then the dataset related to the trigger event may be the customer's KYC (Know Your Customer) information, such as the customer's identification documents, address, employment details, and financial history.

At step S408, the method 400 includes applying, by the at least one processor 104, the plurality of rules to the dataset. For example, in a banking scenario, rule such as “transaction amount exceeds $15000” may be applied to trigger an alert or require manual review.

At step S410, the method 400 includes executing, by the at least one processor, the plurality of rules for performing an action. Once the plurality of rules are applied to the dataset, the at least one processor 104 executes the plurality of rules to perform the action, such as approving a transaction or flagging the transaction for review, and the like. The execution of the plurality of rules may include a set of conditions such as “if the set of conditions for a particular rule are met, the action is to be performed. (e.g., send an approval message, block the transaction, etc.).

In an implementation, the method 400 includes recording, by the at least one processor, an audit trail of the action. The audit trail logs details of execution of each rule of the plurality of rules. For example, in a financial transaction system, any action regarding customer account data (such as transactions, account access, or modifications) is logged to maintain the audit trail. In addition, the audit trail is critical for compliance with regulations such as Financial Industry Regulatory Authority (FINRA) or Anti-Money Laundering (AML) laws.

Also, the method 400 includes saving, by the at least one processor 104, the audit trail in the taxonomy-based datastore. For recording the audit trail of the action, the method 400 further includes logging a set of entries, by the at least one processor 104, for execution of each rule of the plurality of rules. Each entry from the set of entries includes metadata associated with the trigger event. The metadata includes at least timestamps, user identifiers, and rule version. It is to be noted that the metadata is not limited to the mentioned data. In an implementation, when a user accesses any sensitive data, the system might log the event with a timestamp, the user's ID, specific version of a security rule that authorized the access and the like.

At step S412, the method 400 includes storing, by the at least one processor, a result of the action in the taxonomy-based datastore. After the action is performed, the result (whether the action was successful or not) is stored back into the taxonomy-based datastore for future reference or auditing. For example, storing whether a transaction was approved or denied and reasons for the decision. After step S412, the method 400 terminates.

The above methodology provides a technical solution to the noted technical problems of power consumption from excessive testing. Since the rules generation and application process is streamlined in the manner set forth above, errors are far less likely to occur. This reduces the need for continual retesting, with a corresponding overall reduction in consumption of computer resources and electrical power.

The above methodology also provides a technical solution to the technical problem of existing systems struggling with scalability as requiring costly and rigid infrastructure. The rules of the methodology can be adapted and deployed at will, regardless of the supporting system, and can thus scale effectively without compromising performance or resilience.

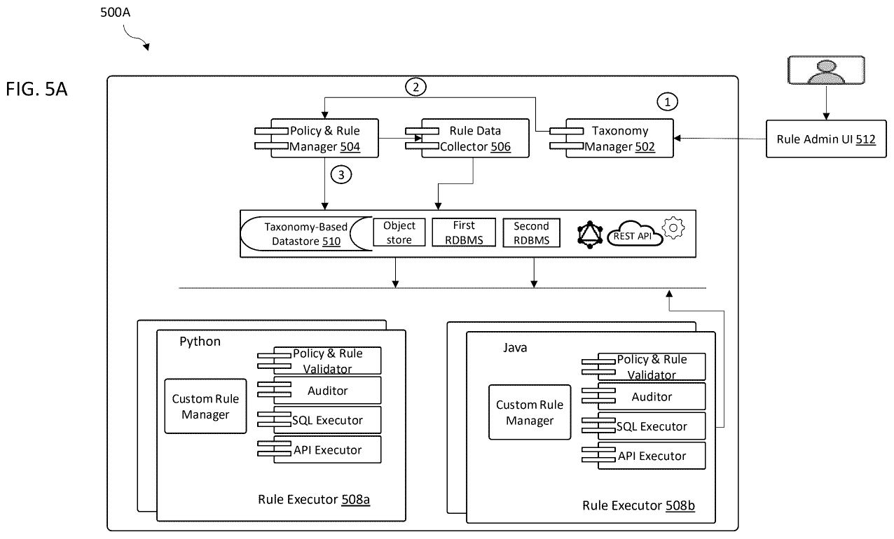

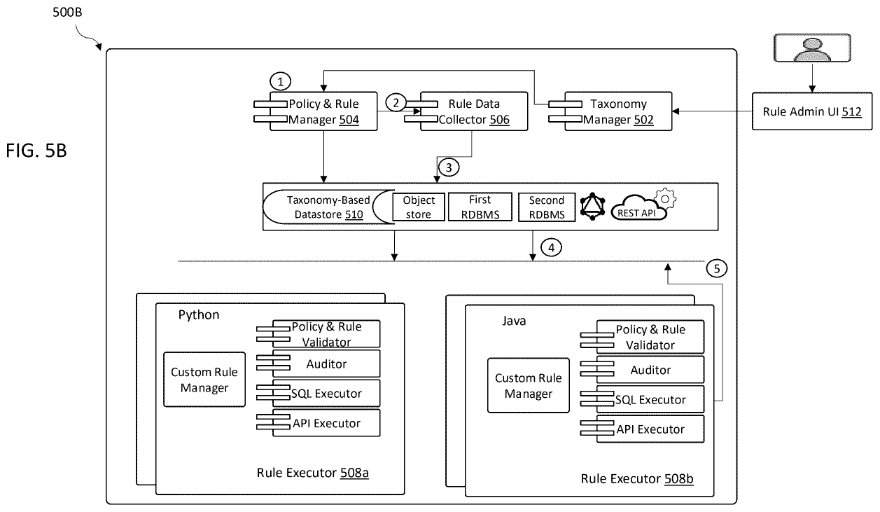

FIG. 5A illustrates an architecture 500A of an exemplary system in view of a rule setup flow, in accordance with an exemplary embodiment of the present disclosure. Further, FIG. 5B illustrates an architecture 500B of the exemplary system (same as exemplary system of FIG. 5A) in view of a rule decision and execution flow.

The exemplary system shown in FIG. 5A and FIG. 5B includes the taxonomy-based framework that further includes a taxonomy manager 502, a policy and rule manager 504, a rule data collector 506, a rule executor 508a, a rule executor 508b, a taxonomy-based datastore 510, and a rule administrator user interface (UI) 512.

As per FIG. 5A, the rule setup flow begins at step 1. At step 1, the taxonomy manager 502 initiates the rule setup flow. The taxonomy manager 502 is associated with the rule administrator UI 512. Further, the rule administrator user interface (UI) 512 allows an administrator to define a plurality of rules and a plurality of policies. The taxonomy manager 502 manages a hierarchical rule taxonomy structure for the plurality of rules associated with the plurality of policies. Furthermore, the taxonomy manager 502 may ensure that the plurality of rules are systematically organized for efficient management and retrieval. At step 2, the taxonomy manager 502 interacts with the policy and rule manager 504 to classify the plurality of policies and the associated plurality of rules into categories and subcategories. At step 3, the classified plurality of policies and the associated plurality of rules are categorized into a hierarchical structure allowing logical organization and stored within the taxonomy-based datastore 510 (as also described in FIG. 4). The taxonomy-based datastore 510 may be associated with/or may encompass an object store, a first relational database management system, a second relation database management system (RDBMS), and a REST API running with a query language “GraphQL”. In general, the object store (also known as object-based storage), is a computer data storage architecture designed to handle large amounts of unstructured data. Further, the first relational database management system (RDBMS) may be a cloud RDBMS. Furthermore, the second RDBMS is an on-premises RDBMS that may be present within the taxonomy-based datastore 510. Also, the REST API is an application programming interface (API) that follows design principles of REST architectural style. REST refers to representational state transfer and is a set of rules and guidelines about how to build a web API. In an implementation, the taxonomy-based datastore 510 is associated with the rule executor 508, explained further in view of FIG. 5B.

As shown in FIG. 5B, the architecture 500B depicts the rule decision and execution flow. The rule decision and execution flow initiates at step 1. At step 1, the policy and rule manager 504 receives a trigger for execution of a rule from the plurality of rules from a triggering service. The trigger may be event based trigger, time based trigger, or user-driven trigger. In an implementation, user-driven trigger is a trigger received from a user and sent to the triggering service. The trigger may also be received from the rule administrator UI 512. As described with respect to FIG. 5A, the plurality of rules and the plurality of policies are categorized into a hierarchical structure, allowing logical organization within the taxonomy-based datastore 510. Further, at step 2, the policy and rule manager 504 interacts with the rule data collector 506 to retrieve the dataset on which the rule will be applied. At step 3, the rule data collector 506 collects the dataset from the taxonomy-based datastore 510. The taxonomy-based datastore 510 is a central repository for storing the plurality of rules, the plurality of policies, classified data and execution results.

Furthermore, at step 4, the policy and rule manager 504 interacts with the rule executor 508a and the rule executor 508b. The rule executor 508a and the rule executor 508b is a technology-agnostic execution module implemented in multiple languages (such as Python and Java respectively). In an implementation, the rule executor 508a is implemented in Python language. In addition, the rule executor 508b is implemented in JAVA language. The rule executors 508a, 508b include a policy and rule validator that is configured to evaluate the plurality of rules using a custom rule manager (such as Drools, SQL-based executors, or API executors) and executes associated actions upon meeting rule conditions.

In general, Drools is a business rule management system (BRMS) with a forward and backward chaining inference-based rules engine, more correctly known as a production rule system. Drools supports the Java Rules Engine API (Java Specification Request 94) standard for its business rule engine and enterprise framework for construction, maintenance, and enforcement of business policies in an organization, application, or service. Further, SQL-based executors refer to systems or components that execute SQL (Structured Query Language) queries to retrieve, manipulate, and manage data from relational databases. These executors are designed to process SQL commands and perform tasks such as querying, updating, deleting, or inserting data based SQL syntax. In an implementation, the rule executor 508a, 508b retrieves the categorized plurality of rules from the taxonomy-based datastore 510 and evaluates them using various execution mechanisms, including customized rule managers like Drools, SQL-based executors, or API executors.

In addition, the rule executors 508a, 508b include an auditor that records an audit trail of an action. The auditor logs a set of entries for each rule update and execution. Each log entry from the set of entries includes metadata associated with the trigger event. The metadata includes at least timestamps, user identifiers, and rule versions.

Further, at step 5, the rule executors 508a, 508b store the associated actions or result of execution in the taxonomy-based datastore 510. Furthermore, the associated actions and the result of execution are displayed at the rule administrator UI 512 via the policy and rule manager 504.

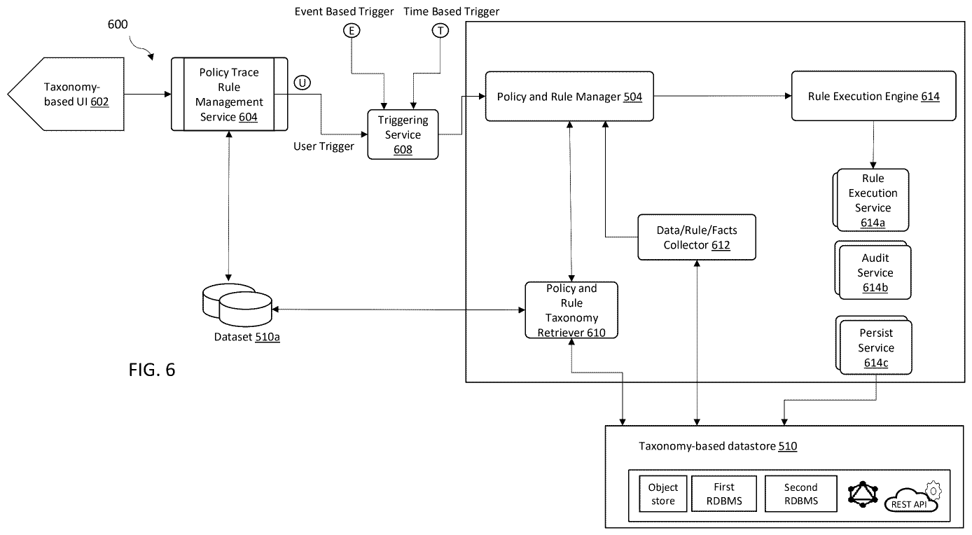

FIG. 6 illustrates another architecture of the exemplary system 600 for providing taxonomy-based framework for policy and rule management, in accordance with an exemplary embodiment of the present disclosure. The exemplary system 600 includes a taxonomy-based user interface (UI) 602. The taxonomy-based user interface (UI) 602 provides a user interface for defining and managing a plurality of policies, a plurality of rules, and associated set of attributes such as rule definition, unique identity, rule type, and rule status.

In an implementation, rule definition refers to a detailed description of each rule of the plurality of rules and its purpose. Further, unique identity refers to a unique identifier assigned to each of the plurality of rules to differentiate the plurality of rules within a taxonomy-based datastore 510. In addition, rule type refers to a type or category of each of the plurality of rules, often used to classify the plurality of rules in a hierarchical classification. For example, rule type may be validation rule, transformation rule, compliance rule and the like. Furthermore, rule status indicates current state of each rule of the plurality of rules. For example, rule status may indicate “draft” which means that a rule is created but not yet made active, rule status indicated as “under testing” means that the rule is being tested with datasets, rule status indicated as “active” means that the rule is validated and made operational, and rule status indicated as “inactive” means that the rule is deactivated due to failed validation or redundancy.

The exemplary system 600 includes a policy trace rule management service 604. The policy trace rule management service 604 serves as a critical service for managing the plurality of rules including creation, enhancement, testing, and status of the plurality of rules. In one implementation, the policy trace rule management service 604 may act as an interface between a taxonomy-based UI 602 and a policy and rule manager 606.

The exemplary system 600 includes a triggering service 608. The triggering service 608 processes synchronous and asynchronous triggers, enabling execution of the plurality of rules upon receiving a trigger event. The triggers may be event based triggers, time based triggers, or user-driven triggers. In an implementation, user-driven triggers are triggers received from a user and sent to the triggering service via the policy trace rule management service 604. The triggering service 608 sends the triggers to the policy and rule manager 504. The policy and rule manager 504 is configured to retrieve a set of rule details from the taxonomy-based datastore 510, via a policy and rule taxonomy retriever 610. Further, the policy and rule manager 504 classifies and organizes the plurality of policies and the plurality of rules in a hierarchical classification within the taxonomy-based datastore 510. Furthermore, the policy and rule manager 504 is in communication with data/rule/facts collector 612 (herein after data collector 612). The data collector 612 is configured to identify and retrieve the dataset on which the plurality of rules are to be applied. The data collector 612 works in tandem with the policy and rule taxonomy retriever 610. Also, the policy and rule manager 504 is in communication with a rule execution engine 614. The rule execution engine 614 is configured to execute the plurality of rules and perform related actions in subservices such as a rule execution service 614a, an audit service 614b, and a persistence service 614c. The rule execution service 614a applies rules to the dataset 510a and executes them. The audit service 614b logs rule executions and updates audit trails for each rule update and execution. The persistence service 614c saves results of rule execution and actions to the taxonomy-based datastore 510.

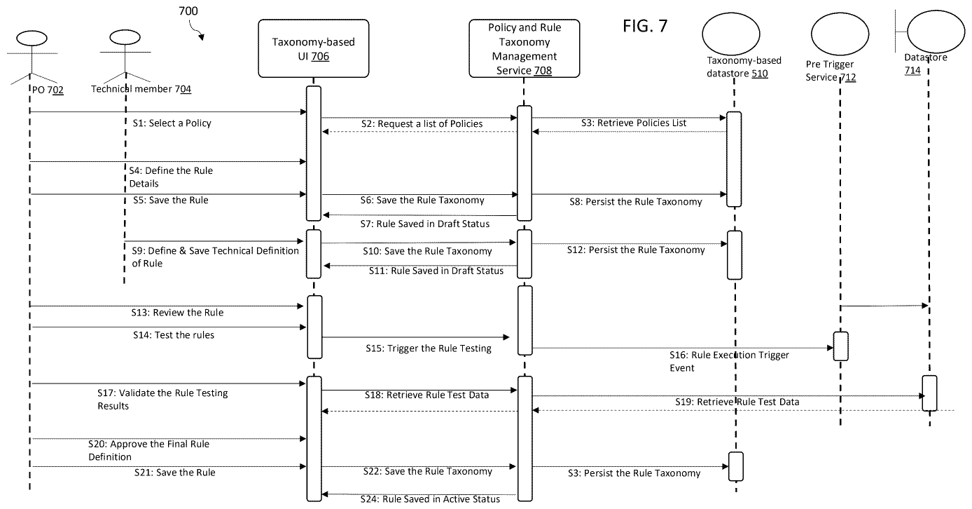

FIG. 7 illustrates a first sequence diagram 700 of an exemplary system to define and approve rules for the taxonomy-based framework for policy and rule management, in accordance with an exemplary embodiment of the present disclosure. In one implementation, a product owner (PO) 702 defines business-level rules for a policy, via a taxonomy-based UI 706. In addition, a technical member 704 is responsible for defining technical implementation (such as technical definition of rule) of the business-level rules for the policy at the taxonomy-based UI 706. Further, a policy and rule taxonomy management service 708 acts as a backend service for persisting rule definitions and managing rule lifecycle. The business-level rules are stored in a taxonomy-based datastore 510.

The sequence diagram initiates at step S1, with the selection of a policy. At step S1, the PO 702 selects the policy via the taxonomy-based UI 706. At step S2, the taxonomy-based UI 706 requests a list of policies from the taxonomy-based datastore 510 via the policy and rule taxonomy management service 708. At step S3, the Policy and rule taxonomy management service 708 retrieves a list of policies from the taxonomy-based datastore 510.

Further, at step S4, the PO 702 defines a set of rule details for the rules associated with the selected policy and at step S5, the PO 702 saves the rules and their details via the taxonomy-based UI 706. At step S6, a rule taxonomy, via the taxonomy-based UI 706, is saved at the policy and rule taxonomy management service 708. At step S7, the rules for the policy are saved in a draft status in the taxonomy-based UI 706. Further, at step S8, the rule taxonomy is persisted in the taxonomy-based datastore 510.

Furthermore, at step S9, the technical member 704 defines and saves the technical implementation of the rule at the taxonomy-based UI 706. At step S10, the technical implementation of the rules is saved via taxonomy-based UI 706 at the policy and rule taxonomy management service 708. Further, the policy and rule taxonomy management service 708, at step S11, is configured to save the rules in draft status at the taxonomy-based UI 706. At step S12, the policy and rule taxonomy management service 708 is configured to persist the rule taxonomy in the taxonomy-based datastore 510.

The defined rule is reviewed by the PO 702, at step S13. Further, rule testing is initiated via the taxonomy-based UI 706, at step S14. The policy and rule taxonomy management service 708 triggers the rule testing, at step S15. As a result of the rule testing trigger, a rule execution trigger event is transmitted by the policy and rule taxonomy management service 708 and is received at a pre-triggering service 712, at step S16. Further, rule testing result after execution of the rules is stored in a datastore 714.

Next, at step S17, the PO 702 initiates validation of the rule testing result at the taxonomy-based UI 706. At step S18 and S19, the rule test data is retrieved from the datastore 714 via the policy and rule taxonomy management service 708. The rule test data is then validated by the PO 702 at the taxonomy-based UI 706 to check whether rule testing result meets the predefined conditions. If validation of the rule testing result is successful, the PO 702 initiates final approval of the rule definition for the rules. If validation of rule testing result is unsuccessful, the rules are adjusted and re-tested until validation succeeds. Upon successful testing and validation, the definition of the rules is finalized and approved by the PO 702, at step S20. At step S21, the PO 702 saves a rule and at step S22, a rule taxonomy is saved at the policy and rule taxonomy management service 708. At step S23, the taxonomy-based datastore 510 is configured to persist the rule taxonomy. Finally, at step S24, the rule status is changed from draft status to active status in the taxonomy-based datastore 510 via the policy and rule taxonomy management service 708. Thereafter, the rules with active status are set for execution.

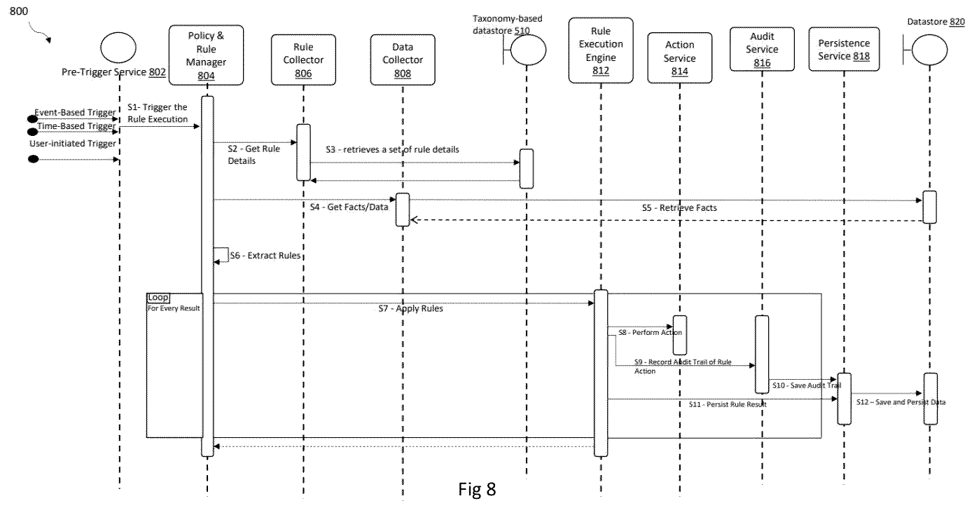

FIG. 8 illustrates a second sequence diagram 800 of an exemplary system to trigger execution of rules for a taxonomy-based framework for policy and rule management and execution, in accordance with an exemplary embodiment of the present disclosure.

The sequence of operations initiates with a pre-trigger service 802. The pre-trigger service 802 initiates rule execution process based on a trigger, at step S1. The trigger may be an event-based trigger (triggered by specific event such as transaction), a time-based trigger (triggered periodically (e.g., daily checks)), and a user-initiated trigger (manually triggered by a user action). The trigger notifies a policy and rule manager 804 to start processing a plurality of rules. Based on the trigger, at step S2, the policy and rule manager 804 requests a set of rule details (‘Get Rule Details’) for the plurality of rules from a rule collector 806.

The rule collector 806, at step S3, retrieves a set of rule details from a taxonomy-based datastore 510, which stores the plurality of rules in a hierarchical classification (already explained with respect to FIG. 4). In addition, at step S4, the policy and rule manager 804 communicates with a data collector 808 to retrieve datasets or facts on which the plurality of rules will be applied. At step S5, the data collector 808 retrieves facts from the datastore 720. Also, at step S6, the policy and rule manager 804 extracts the rules based on the retrieved facts at step S5. Further, at step S7, the policy and rule manager 804 directs the rule execution engine 812 to apply rules. At step S8, for each rule, a rule execution engine 812 applies a rule logic to the corresponding dataset. Further, the rule execution engine 812 delegates actions to be performed by an action service 814. At step S9, the rule execution engine 812 records audit trails via an audit service 816. The action service 814 executes the actions defined by the plurality of rules (e.g., flagging a record, triggering a workflow, etc.). At step S10, the audit service 816 saves or logs audit trails of rule execution for traceability and compliance purposes at a persistence service 818. At step S11, the rule execution engine 812 persists results of execution of the plurality of rules via a persistence service 818. Further, at step S12, the persistence service 818 saves results of execution and audit trails into a datastore 820 and persists the same. The datastore 820 may be a centralized storage for the plurality of rules, execution results and the like.

It would be appreciated by the person skilled in the art that the disclosed method offers an intelligent solution for providing taxonomy-based framework for policy and rule management and execution for the plurality of policies.

The present disclosure provides numerous advantages as given below. The present disclosure provides a taxonomy-based framework for policy and rule management and execution. The present disclosure uses a structured approach to classify rules, making them easy to manage and scale. The system handles the entire process-from creating and testing rules to executing and tracking them-ensuring everything runs smoothly and can be improved over time. It keeps detailed records for transparency, which is especially helpful for audits and compliance. The system is flexible, allowing it to connect to various data sources and work in different environments. Its modular design means each part can be scaled independently, saving costs and improving performance. It also has built-in tools to test rules before use, reducing errors, and supports real-time execution, making it suitable for fast and dynamic decision-making. Overall, the present disclosure provides a taxonomy-based framework for managing and executing complex rules and policies.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to a non-transitory computer-readable storage medium storing instructions for providing taxonomy-based framework for policy and rule management is disclosed. The instructions include executable code which, when executed by a processor 104, may cause the processor 104 to receive, via a policy and rule manager, a trigger event from a service for execution of a plurality of rules associated with the plurality of policies; retrieve a set of rule details for the plurality of rules from a taxonomy-based datastore; retrieve a dataset for applying the plurality of rules, from the taxonomy-based datastore; apply the plurality of rules to the dataset to trigger execution of the plurality of rules; execute the plurality of rules for performing an action; and store result of the action in the taxonomy-based datastore.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for providing taxonomy-based framework for policy and rule management, the method being implemented by at least one processor, the method comprising:
classifying, by the at least one processor, a plurality of rules based on a plurality of pre-defined rule-taxonomy categories;
organizing, by the at least one processor, the plurality of rules as classified in a hierarchical taxonomy structure within a taxonomy-based datastore;
testing the plurality of rules as organized with the hierarchical taxonomy structure;
validating the plurality of rules as organized with the hierarchical taxonomy structure in response to successful testing of the plurality of rules;
receiving, by the at least one processor, using a policy and rule manager, a trigger event from a service for execution of the plurality of rules associated with a plurality of policies;
retrieving, by the at least one processor, a set of rule details for the plurality of rules from the taxonomy-based datastore;
retrieving, by the at least one processor, a dataset for applying the plurality of rules, from the taxonomy-based datastore;
applying, by the at least one processor, the plurality of rules to the dataset to trigger execution of the plurality of rules;
executing, by the at least one processor, the plurality of rules for performing an action; and
storing, by the at least one processor, a result of the action in the taxonomy-based datastore.

2. The method as claimed in claim 1, wherein the plurality of rules are defined to be executed in sequence.

3. (canceled)

4. The method as claimed in claim 1, wherein the method further comprises:
recording, by the at least one processor, an audit trail of the action; and
saving, by the at least one processor, the audit trail in the taxonomy-based datastore.

5. The method as claimed in claim 4, wherein for recording the audit trail of the action, the method further comprises:
logging a set of entries, by the at least one processor, for execution of each rule of the plurality of rules, wherein each entry from the set of entries comprises metadata associated with the trigger event, wherein the metadata comprises at least a timestamp, a user identifier, and a rule version.

6. The method as claimed in claim 1, wherein prior to receiving the trigger event, the method comprises:
defining a plurality of rule attributes for the plurality of rules, wherein the plurality of rule attributes comprises at least one from among rule definition, rule unique identity, rule type, and rule status.

7. (canceled)

8. The method as claimed in claim 1, wherein for testing the plurality of rules, the method further comprises:
retrieving, by the at least one processor, a rule test data associated with the plurality of rules for the plurality of policies from a plurality of sources;
evaluating, by the at least one processor, the rule test data to generate rule testing result, wherein the rule testing result is generated by comparing the rule test data with a plurality of predefined conditions associated with the plurality of policies;
verifying, by the at least one processor, whether the rule testing result meets the plurality of predefined conditions; and
adjusting, by the at least one processor, the plurality of rules based on the rule testing result if the rule testing result fails to meet the plurality of predefined conditions.

9. The method as claimed in claim 8, wherein the method further comprises:
updating, by the at least one processor in response to the validating, a rule status of each of the plurality of rules to one of an active status and an inactive status, wherein the active status indicates successful validation and the inactive status indicates unsuccessful validation.

10. A computing device configured to provide taxonomy-based framework for policy and rule management, the computing device comprising:
a processor;
a memory storing instructions; and
a communication interface coupled to each of the processor and the memory, wherein the processor is programmed to cooperate with the instructions to perform operations comprising:
classify, by the processor, a plurality of rules based on a plurality of pre-defined rule-taxonomy categories;
organize, by the processor, the plurality of rules as classified in a hierarchical taxonomy structure within a taxonomy-based datastore;
test the plurality of rules as organized with the hierarchical taxonomy structure;
validate the plurality of rules as organized with the hierarchical taxonomy structure in response to successful testing of the plurality of rules;
receive, via a policy and rule manager, a trigger event from a service for execution of the plurality of rules associated with a plurality of policies;
retrieve a set of rule details for the plurality of rules from the taxonomy-based datastore;
retrieve a dataset for applying the plurality of rules, from the taxonomy-based datastore;
apply the plurality of rules to the dataset to trigger execution of the plurality of rules;
execute the plurality of rules for performing an action; and
store a result of the action in the taxonomy-based datastore.

11. The computing device as claimed in claim 10, wherein the plurality of rules are defined to be executed in sequence.

12. (canceled)

13. The computing device as claimed in claim 10, wherein the operations further comprise:
record an audit trail of the action; and
save the audit trail in the taxonomy-based datastore.

14. The computing device as claimed in claim 13, wherein to record the audit trail of the action, the operations further comprise:
log a set of entries for execution of each rule of the plurality of rules, wherein each entry from the set of entries comprises metadata associated with the trigger event, wherein the metadata comprises at least a timestamp, a user identifier, and a rule version.

15. The computing device as claimed in claim 10, wherein prior to the receive the trigger event, the operations further comprise:
define a plurality of rule attributes for the plurality of rules, wherein the plurality of rule attributes comprises at least one from among rule definition, rule unique identity, rule type, and rule status.

16. (canceled)

17. The computing device as claimed in claim 10, wherein to test the plurality of rules, the operations further comprise:
retrieve a rule test data associated with the plurality of rules for the plurality of policies from a plurality of sources;
evaluate the rule test data to generate rule testing result, wherein the rule testing result is generated by comparing the rule test data with a plurality of predefined conditions associated with the plurality of policies;
verify whether the rule testing result meets the plurality of predefined conditions; and
adjust the plurality of rules based on the rule testing result if the rule testing result fails to meet the plurality of predefined conditions.

18. The computing device as claimed in claim 17, wherein to the operations further comprise:
update, in response to the validate, a rule status of each of the plurality of rules to one of an active status and an inactive status, wherein the active status indicates successful validation and the inactive status indicates unsuccessful validation.

19. A non-transitory computer readable storage medium storing instruction for providing taxonomy-based framework for policy and rule management, the instructions comprising executable code which when executed by a processor, causes the processor to perform operations comprising:
classify, by the processor, a plurality of rules based on a plurality of pre-defined rule-taxonomy categories;
organize, by the processor, the plurality of rules as classified in a hierarchical taxonomy structure within a taxonomy-based datastore;
teste the plurality of rules as organized with the hierarchical taxonomy structure;
validate the plurality of rules as organized with the hierarchical taxonomy structure in response to successful testing of the plurality of rules;
receive, via a policy and rule manager, a trigger event from a service for execution of the plurality of rules associated with a plurality of policies;
retrieve a set of rule details for the plurality of rules from the taxonomy-based datastore;
retrieve a dataset for applying the plurality of rules, from the taxonomy-based datastore;
apply the plurality of rules to the dataset to trigger execution of the plurality of rules;
execute the plurality of rules for performing an action; and
store a result of the action in the taxonomy-based datastore.

20. The storage medium as claimed in claim 19, wherein the plurality of rules are defined to be executed in a sequence.
